(19) United States
(12) Patent Application Publication
(10) Pub. No.: US 2014/0240204 A1
(43) Pub. Date: Aug. 28, 2014

(54) HEAD-UP DISPLAY DEVICE FOR A SMART PHONE

(71) Applicant: E-LEAD ELECTRONIC CO., LTD., Changhua (TW)

(72) Inventor: Stephen CHEN, CHANGHUA (TW)

(73) Assignee: E-LEAD ELECTRONIC CO., LTD., CHANGHUA (TW)

(21) Appl. No.: 13/774,839

(22) Filed: Feb. 22, 2013

(51) Int. Cl. G06F 3/14

(52) U.S. Cl. CPC G06F 3/14
USPC 345/2.3

(57) ABSTRACT

A head-up display device for a smart phone, which includes a satellite positioning module, a short-distance wireless transmission module, a base, a display module, a light sensor, and a semitransparent reflective film, wherein the short-distance wireless transmission is used to receive the related message data sent by the smart phone and the satellite positioning module, and the image is displayed on the semitransparent reflective film by mirror image method after displaying by the display module, to thereby avoid the danger of the driver lowering head for reading messages, to ensure road safety.

### BACKGROUND OF THE INVENTION

1. Field of the Invention

A head-up display device for a smart phone and, more particularly, to the head-up display device for connecting to a smart phone to display message image on the windshield of the car, to thereby avoid the danger of the driver lowering head for reading messages, to ensure road safety.

2. Brief Description of the Related Art

The smart phone has great function. With the development of the internet and wireless communication technology, many electronic devices are displaced by the smart phone gradually. The smart phone can not only be used to receive external messages at any time, but also can be used as a navigation device, and also can be used to access internet or exchange messages with friends. Although, the smart phone is really convenient, the distraction or diverting attention away from the road due to operating and reading may cause danger to driving safety. Therefore, many nations legislated to limit drivers using smart phones in the car. Even so, since the smart phone may be used as a car navigation device, many drivers place the smart phone on the instrument desk by using a fixed holder. The driver may avoid violating traffic regulations in this way, but the smart phone may block the driver's line of sight, once when car collision happens, it is easy to cause danger to the driver or passengers. And it is more important that the driver needs to operate the smart phone at any time, and traffic safety may be directly affected.

The head-up display device is from the aviation technology originally. The head-up display device may directly project messages in front of the cockpit, and pilots may conveniently obtain desired messages without lowering head to check the messages on the instrument board, pilots can easily combine the messages displayed by the head-up display with the outside scene. Since the image reflected into eyes and the central axis of the aircraft is balanced, the height of pilots may not cause error on pitch angles or visual aim. Therefore, the purpose of the head-up display is that pilots may always keep the head-up posture without lowering head to check the messages displayed on the instrument board, to reduce ignoring the rapid change in the external environment during the interval between lowering head and heading-up, and avoid the delay and discomfort due to eyes focal length is adjusted continuously.

It is one of the biggest main reasons of car accidents that drivers' line of sight is away from the front road when driving. In order to reduce the frequency and duration that drivers' line of sight away from the front road, some car manufacturers equip this kind of head-up display inside the luxury cars, thus, the drivers know the information, such as car speed and engine speed, without moving line of sight away from the front windshield, to maintain traffic safety.

In general driving condition, the shortest time of moving the line of sight away from the front road for reading the information displayed on the instrument board is 0.5 second. For the condition of highway speed of 100 km per hour, the car travels 30 meters per second, and the risk is increased when there are a lot of cars on the road. For safety, the car manufacturers may equip the head-up display in some cars to reduce the distraction of drivers, and the head-up display is used as marking practices to attract consumers.

Recently, the technique of the head-up displays used in the cars is less complicated than the head-up displays equipped in aircrafts. It is one kind of optical system, and generally it is consisted of two main equipments, which are a projector and a combiner. The projector is consisted of signal light sources, projection lens and other optical components. The signal light source of the projector is consisted of LCD monitors or CRT equipments. Light is emitted from the signal light source and projected to the combiner on the glass (or a special transparent screen) by the projector, and the combiner displays words or images.

In the recent years, there are many head-up displays for installation in car in the market. These head-up displays may simply display car speed and engine speed, now display water temperature, throttle position, fuel, over-speed warning, reverse image, battery voltage, and even combine the speed radar. Some products are stressed as quick installation, which are just connected to the car PC without using other cables. In the luxury cars of some car manufacturers, the information of the navigation system, front and rear vehicle distance is added into the information displayed by the head-up display, which is increased a lot of convenience for drivers. Besides, the external head-up displays in the market is various, and the prices are from several hundred dollars for simple function ones, to ten thousand dollars for good quality and versatile ones.

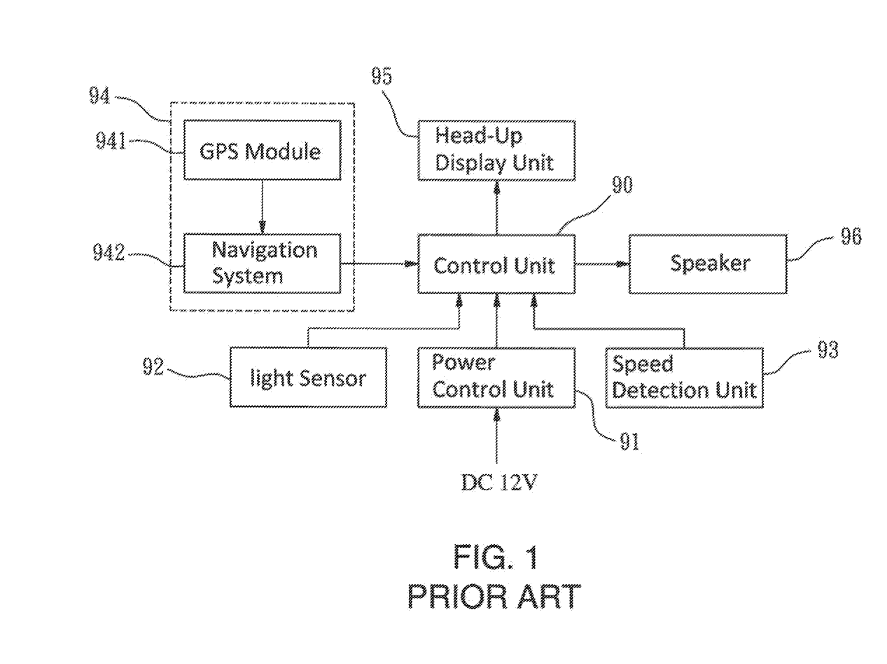

The abovementioned head-up display devices or equipments have been popular car equipments nowadays, the applications of related patent technology are numerous, the cited reference TW M340516 as shown in FIG. 1 is a typical representative, the cited reference is a car head-up display monitor with global positioning satellite, which at least comprises: a control unit 90, the control unit is electrically connected to a power control unit 91, the power control unit 91 is connect to the DC12V of the power source of the car for supplying power; a global positioning satellite unit 94, which is used to process positioning and navigation signals to the control unit 90, includes a global positioning satellite (GPS) module 941 and a navigation system 942, the navigation system 942 is used to process the signals sent from the global positioning satellite module 941 to form a navigation indicating message sending to the control unit 90; and a head-up display unit 95, which is electrically connected to the control unit 90; The positioning information and navigation indications of the global positioning satellite unit 94 are projected on the windshield of the car by the head-up display unit 95; wherein a speed detection unit 93 connected to the control unit 90 is used to detect the road speed limit information and send it to the control unit 90, and the road speed limit information is projected on the windshield of the car by the head-up display unit 95, the control unit is further electrically connected to a light sensor 92 for automatically modulating the brightness of the head-up display unit 95, the control unit 90 may be connected to a speaker 96 for providing a warning function when exceeding the speed limit. The composition of the above elements is generally known technology, and with the function improvement and the feature of multiple supporting of smart phones, it can be sure that the technology of the conventional head-up display monitors or devices cannot satisfy the needs of modern drivers. The functions, such as connecting the broadcasting function of smart phone to the car audio for sound playing or performing the hands-free operation, and connecting to camera lens for providing reversing image, are the faced and expected to be solved technical bottleneck of the current head-up display monitors or devices in the market.

### SUMMARY OF THE INVENTION

In view of the drawbacks of the conventional ones, the inventor finally completed the head-up display device for a smart phone of the present invention after numerous improvements, namely, the object of the present invention is to provide a head-up display device for connecting to a smart phone to display message image on the windshield of the car, to thereby avoid the danger of the driver lowering head for reading messages, to ensure road safety.

To achieve the purpose of the present invention, the first embodiment of the head-up display device for a smart phone of the present invention, includes:

a satellite positioning module, which is used to receive the messages from the satellite positioning system to detect the car position;

a short-distance wireless transmission module, which is used to connect to a smart phone, send satellite positioning information to the smart phone, and receive the related display information sent from the smart phone;

a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;

a display module, which is electrically connected to the circuit board, is installed on the display opening and used to receive the images output from the circuit board and display the image as a mirror image;

a light sensing module, which is electrically connected to the circuit board, is used to sense the brightness of the environment to modulate the brightness of the display module;

a semitransparent reflective film, which is pasted on the inner side of the front windshield of the car to display the image of the display module as mirror images.

The head-up display device for a smart phone further includes a speaker, which is used to play voice files or warning sound sent from the smart phone

The second embodiment of the head-up display device for a smart phone of the present invention, which includes:

a satellite positioning module, which is used to receive the messages from the satellite positioning system to detect the car position;

a short-distance wireless transmission module, which is used to connect to a smart phone, send satellite positioning information to the smart phone, and receive the related display information sent from the smart phone;

a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;

a stereo audio output port, which is electrically connected to the circuit board, is used to play the music files from the smart phone, the smart phone wirelessly sends a sound signal to the short-distance wireless transmission module, the sound signal is sent to the stereo audio output port through the circuit board, the stereo audio output port is connected to a car audio, and the sound signal is played by the car audio;

a speaker, which is electrically connected to the circuit board, is used to play voice files or warning sound sent from the smart phone

a display module, which is electrically connected to the circuit board, is installed on the display opening and used to receive the images output from the circuit board and display the image as a mirror image;

a light sensing module, which is electrically connected to the circuit board, is used to sense the brightness of the environment to modulate the brightness of the display module;

a semitransparent reflective film, which is pasted on the inner side of the front windshield of the car to display the image of the display module as mirror images.

The above stereo audio output port, wherein the transmission of the sound signal is through a wire connected to the AUX input port of the car audio.

The above stereo audio output port, which is a FM wireless transmitter, is used to transmit the sound signal for the FM receiver of the car audio receiving.

The head-up display device for a smart phone further includes a microphone, which is electrically connected to the circuit board, is used with the speaker as a hands-free function.

The third embodiment of the head-up display device for a smart phone of the present invention, which includes:

a portable storage media slot;

a satellite positioning module, which is used to receive the messages from the satellite positioning system to detect the car position;

a short-distance wireless transmission module, which is used to connect to a smart phone, send satellite positioning information to the smart phone, and receive the related display information sent from the smart phone;

a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;

a stereo audio output port, which is electrically connected to the circuit board, is used to play the music files from the smart phone, the smart phone wirelessly sends a sound signal to the short-distance wireless transmission module, the sound signal is sent to the stereo audio output port through the circuit board, the stereo audio output port is connected to a car audio, and the sound signal is played by the car audio;

a speaker, which is electrically connected to the circuit board, is used to play voice files or warning sound sent from the smart phone

a display module, which is electrically connected to the circuit board, is installed on the display opening and used to receive the images output from the circuit board and display the image as a mirror image;

a light sensing module, which is electrically connected to the circuit board, is used to sense the brightness of the environment to modulate the brightness of the display module;

a semitransparent reflective film, which is pasted on the inner side of the front windshield of the car to display the image of the display module as mirror images.

The head-up display device for a smart phone further includes a microphone, which is electrically connected to the circuit board, is used with the speaker as a hands-free function.

The above stereo audio output port, wherein the transmission of the sound signal is through a wire connected to the AUX input port of the car audio.

The above stereo audio output port, which is a FM wireless transmitter, is used to transmit the sound signal for the FM receiver of the car audio receiving.

The base of the above embodiments is placed on the instrument desk of the car, or embedded into the instrument desk under the front windshield.

The display module of the above embodiments, whose brightness is achieved at least 2500 nix.

The head-up display device for a smart phone of the above embodiments, further includes a camera lens, the head-up display device is automatically switched to display the image of the camera lens as the reverse view function when the camera lens starting.

The short-distance wireless transmission module of the above embodiments is a Bluetooth or a Wi-Fi module.

### BRIEF DESCRIPTION OF THE INVENTION

The detail structure, the applied principle, the function and the effectiveness of the present invention can be more fully understood with reference to the following description and accompanying drawings, in which:

FIG. 1 is a function block diagram of the prior art;

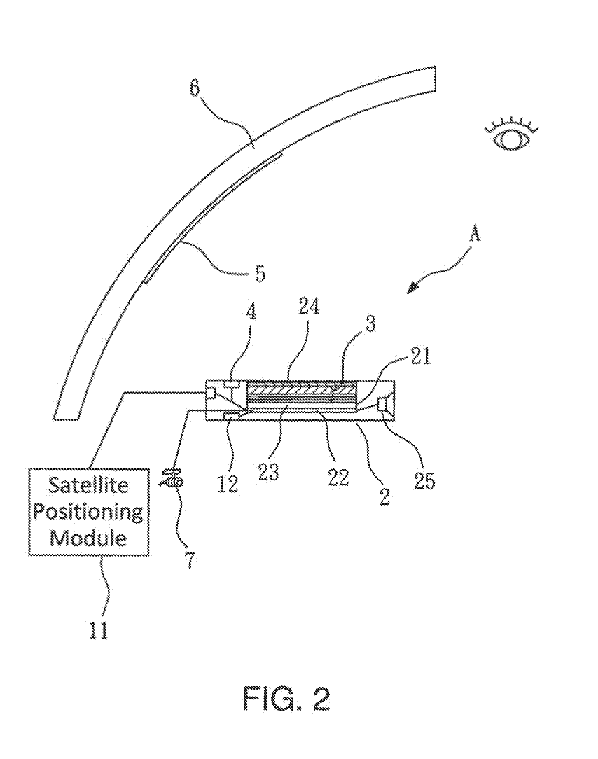

FIG. 2 is a structural diagram of the first embodiment according to the present invention;

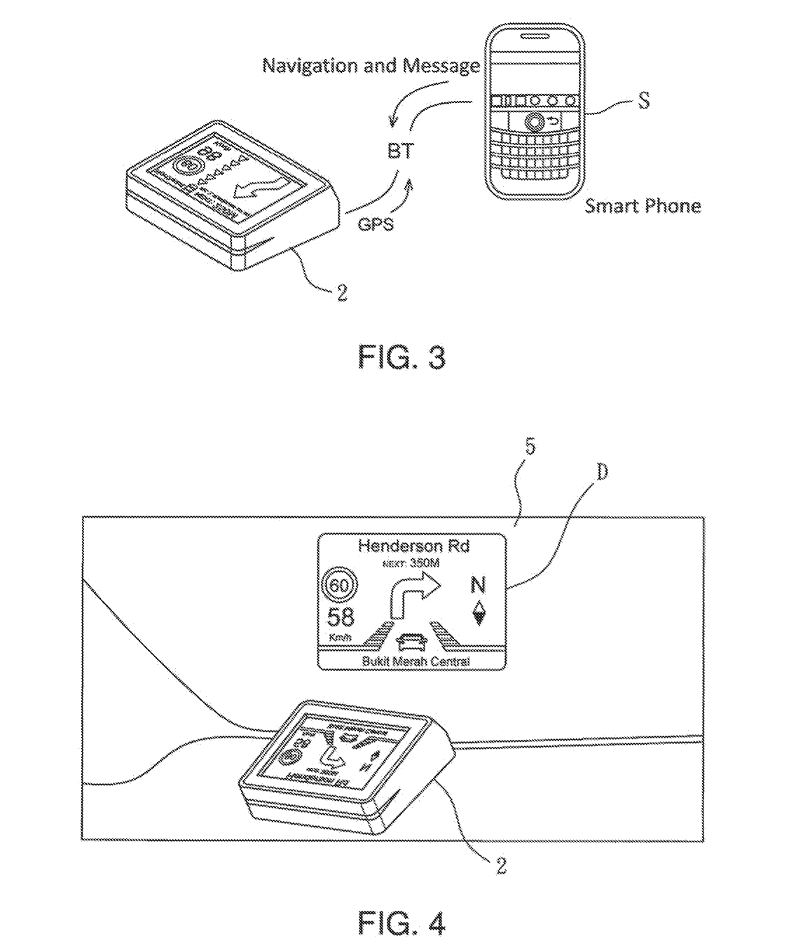

FIG. 3 is a action diagram (1) of the present invention;

FIG. 4 is a action diagram (2) of the present invention;

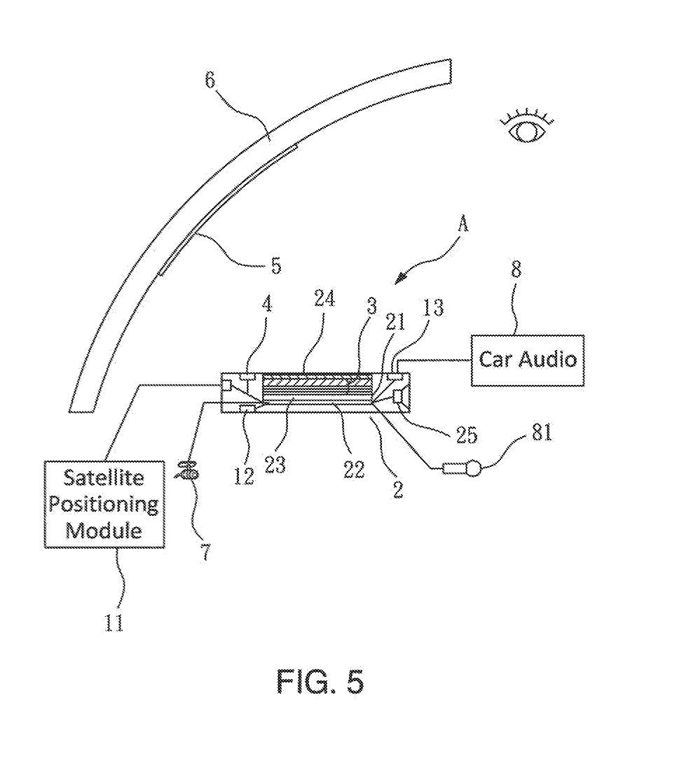

FIG. 5 is a structural diagram of the second embodiment according to the present invention; and

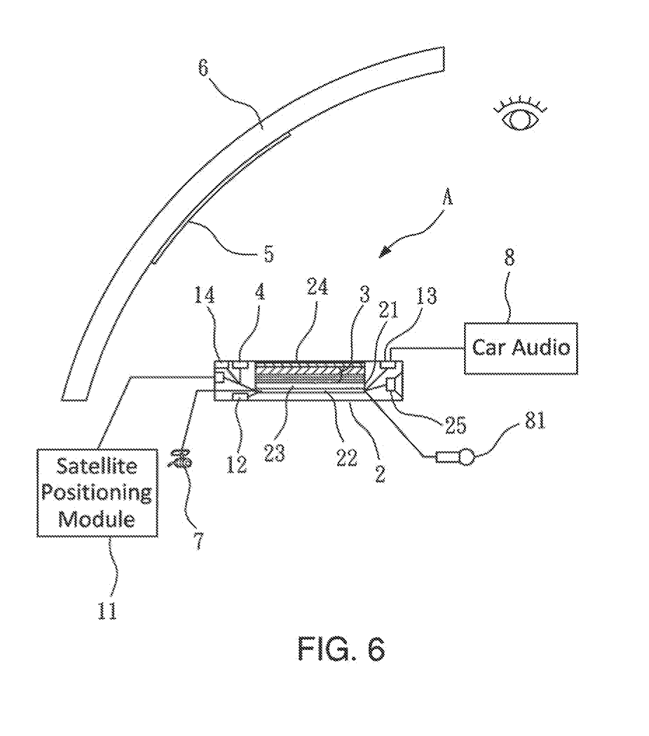

FIG. 6 is a structural diagram of the third embodiment according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

As shown in FIG. 2, FIG. 3 and FIG. 4, it is the first embodiment of the head-up display device A for a smart phone of the present invention, which includes:

a satellite positioning module 11, which is used to receive the messages from the satellite positioning system to detect the car position;

a short-distance wireless transmission module 12, which is used to connect to a smart phone S, send satellite positioning information to the smart phone S, and receive the related display information sent from the smart phone S;

a base 2, wherein a capacity space 21 is set inside for placing a circuit board 22, the circuit board 22 includes a processor 23, which is electrically connected to the satellite positioning module 11 and the short-distance wireless transmission module 12 and is used to control information processing and displaying, and a display opening 24 is set on the surface of the base 2;

a display module 3, which is electrically connected to the circuit board 22, is installed on the display opening 24 and used to receive the images output from the circuit board 22 and display the image as a mirror image;

a light sensing module 4, which is electrically connected to the circuit board 22, is used to sense the brightness of the environment to modulate the brightness of the display module 3;

a semitransparent reflective film 5, which is pasted on the inner side of the front windshield 6 of the car to display the image of the display module 3 as mirror images.

By the head-up display device for a smart phone A consisted of the above elements, the driver can set it up well before driving, such as the navigation set-up, traffic messages displaying set-up, and important real-time information displaying set-up. After driving on the road, the head-up display device for a smart phone may display automatically based on the set-up without operating by the driver any time, the display module 3 automatically displays the instruction of turning in the intersection; the head-up display device for a smart phone A could further display the car speed any time, the instant car speed may be calculated by the internal satellite positioning module 11 and displayed on the display module 3 even when unconnected with the smart phone S, the display module 3 displays the images on the semitransparent reflective film 5 as a mirror image and display a image D of message image, to avoid the driver lowering head to watch the speedometer of the instrument panel, so it is quite helpful for driving safety.

The head-up display device for a smart phone A further includes a speaker 25, which is electrically connected to the circuit board 22, is used to play voice files or warning sound sent from the smart phone S;

As shown in FIG. 3, FIG. 4, FIG. 5, it is the second embodiment of the head-up display device A for a smart phone of the present invention, which includes:

a satellite positioning module 11, which is used to receive the messages from the satellite positioning system to detect the car position;

a short-distance wireless transmission module 12, which is used to connect to a smart phone S, send satellite positioning information to the smart phone S, and receive the related display information sent from the smart phone S;

a base 2, wherein a capacity space 21 is set inside for placing a circuit board 22, the circuit board 22 includes a processor 23, which is electrically connected to the satellite positioning module 11 and the short-distance wireless transmission module 12 and is used to control information processing and displaying, and a display opening 24 is set on the surface of the base 2;

a stereo audio output port 13, which is electrically connected to the circuit board 22, and used to play the music file from the smart phone, the sound signal is transmitted wirelessly to the short-distance wireless transmission module 12 from the smart phone S, the sound signal is sent to the stereo audio output port 13 through the circuit board 22, and the stereo audio output port is connected to a car audio 8 for playing sound;

a speaker 25, which is electrically connected to the circuit board 22, is used to play voice files or warning sound sent from the smart phone S;

a display module 3, which is electrically connected to the circuit board 22, is installed on the display opening 24 and used to display the image as a mirror image, and also display the playing tracks;

a light sensing module 4, which is electrically connected to the circuit board 22, is used to sense the brightness of the environment to modulate the brightness of the display module 3;

a semitransparent reflective film 5, which is pasted on the inner side of the front windshield 6 of the car to display the image of the display module 3 as mirror images.

The head-up display device A for a smart phone further includes a microphone 81, which is electrically connected to the circuit board 22, is used with the speaker 8 as a hands-free function.

By the head-up display device for a smart phone A consisted of the above elements, the driver can set it up well before driving, such as the navigation set-up, traffic messages displaying set-up, and important real-time information displaying set-up. After driving on the road, the head-up display device for a smart phone A may display automatically based on the set-up without operating by the driver any time, the display module 3 automatically displays the instruction of turning in the intersection, and the speaker 25 performs voice guide simultaneously; the head-up display device for a smart phone A could further display the car speed any time, the instant car speed may be calculated by the internal satellite positioning module 11 and displayed on the display module 3 even when unconnected with the smart phone S, the display module 3 displays the images on the semitransparent reflective film 5 as a mirror image and display a image D of message image, to avoid the driver lowering head to watch the speedometer of the instrument panel, so it is quite helpful for driving safety.

The above stereo audio output port 13 is wired connected to the AUX input port of the car audio 8, and may also be a FM wireless transmitter, which transmit the sound signal wirelessly, and the sound signal is received by the FM receiver of the car audio 8.

The head-up display device for a smart phone A of the present invention, when outputting the sound of the smart phone S (such as playing music), the stereo audio output port 13 may further be used to send sound files to the car audio 8 for playing, the display module 3 also display the playing tracks.

As shown in FIG. 3, FIG. 4, FIG. 6, it is the third embodiment of the head-up display device A for a smart phone of the present invention, which includes:

a portable storage media slot 14, which is used to access the music files in a SD card or a USB flash device;

a satellite positioning module 11, which is used to receive the messages from the satellite positioning system to detect the car position;

a short-distance wireless transmission module 12, which is used to connect to a smart phone S, send satellite positioning information to the smart phone S, and receive the related display information sent from the smart phone S;

a base 2, wherein a capacity space 21 is set inside for placing a circuit board 22, the circuit board 22 includes a processor 23, which is electrically connected to the satellite positioning module 11 and the short-distance wireless transmission module 12 and is used to control information processing and displaying, and a display opening 24 is set on the surface of the base 2;

a stereo audio output port 13, which is electrically connected to the circuit board 22, the music file of a portable storage media inserted into the portable storage media slot 14 is played by the multimedia playing software, the sound signal of the music file is sent to the stereo audio output port 13 through the circuit board 22, the stereo audio output port is connected to a car audio 8, and the sound signal is played by the car audio 8;

a speaker 25, which is electrically connected to the circuit board 22, is used to play voice files or warning sound sent from the smart phone S;

a display module 3, which is electrically connected to the circuit board 22, is installed on the display opening 24 and used to display the image as a mirror image, and also display the playing tracks;

a light sensing module 4, which is electrically connected to the circuit board 22, is used to sense the brightness of the environment to modulate the brightness of the display module 3;

a semitransparent reflective film 5, which is pasted on the inner side of the front windshield 6 of the car to display the image of the display module 3 as mirror images.

The head-up display device A for a smart phone further includes a microphone 81, which is electrically connected to the circuit board 22, is used with the speaker 8 as a hands-free function.

By the head-up display device for a smart phone A consisted of the above elements, the driver can set it up well before driving, such as the navigation set-up, traffic messages displaying set-up, and important real-time information displaying set-up. After driving on the road, the head-up display device for a smart phone A may display automatically based on the set-up without operating by the driver any time, the display module 3 automatically displays the instruction of turning in the intersection, and the speaker 25 performs voice guide simultaneously; the head-up display device for a smart phone A could further display the car speed any time, the instant car speed may be calculated by the internal satellite positioning module 11 and displayed on the display module 3 even when unconnected with the smart phone S, the display module 3 displays the images on the semitransparent reflective film 5 as a mirror image and display a image D of message image, to avoid the driver lowering head to watch the speedometer of the instrument panel, so it is quite helpful for driving safety.

The above stereo audio output port 13, which is wired connected to the AUX input port of the car audio 8, may also be a FM wireless transmitter, which sends the sound signal wirelessly, and the FM receiver of the car audio 8 receives the sound signal.

The head-up display device for a smart phone A of the present invention, when playing multimedia, the sound signal may further be sent to the car audio 8 through the stereo audio output port 13, the display module 3 displays the playing tracks.

The head-up display device for a smart phone A of the present invention, the hands-free operation may further be performed through the speaker 25 and the microphone 81.

The display module 3 of the above embodiments, has mirror image display function with high brightness, the car speed may be displayed when it is unconnected to the smart phone S, and when it is wirelessly connected to the smart phone S, in addition to the car speed, the information sent by APP software of the smart phone S may further be displayed.

The base 2 of the above embodiments, is placed on the instrument desk of the car, or embedded into the instrument desk under the front windshield.

The display module 3 of the above embodiments, whose brightness is achieved at least 2500 nix.

The head-up display device for a smart phone A of the above embodiments further includes a camera lens 7, wherein the head-up display device is automatically switched to display the image of the camera lens 7 as the reverse view function when the camera lens starting.

The short-distance wireless transmission module 12 of the above embodiments is a Bluetooth or a Wi-Fi module.

I claim:

1. A head-up display device for a smart phone, which includes:
a satellite positioning module, which is used to receive the messages from the satellite positioning system to detect the car position;
a short-distance wireless transmission module, which is used to connect to a smart phone, send satellite positioning information to the smart phone, and receive the related display information sent from the smart phone;
a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;
a display module, which is electrically connected to the circuit board, is installed on the display opening and used to receive the images output from the circuit board and display the image as a mirror image;
a light sensing module, which is electrically connected to the circuit board, is used to sense the brightness of the environment to modulate the brightness of the display module;
a semitransparent reflective film, which is pasted on the inner side of the front windshield of the car to display the image of the display module as mirror images.

2. The head-up display device for a smart phone as claimed in claim 1, wherein the base is placed on the instrument desk of the car, or embedded into the instrument desk under the front windshield.

3. The head-up display device for a smart phone as claimed in claim 1, further includes a camera lens, wherein the head-up display device is automatically switched to display the image of the camera lens as the reverse view function when the camera lens starting.

4. The head-up display device for a smart phone as claimed in claim 1, further includes a speaker, which is used to play voice files or warning sound sent from the smart phone.

5. The head-up display device for a smart phone as claimed in claim 1, wherein the short-distance wireless transmission module is a Bluetooth or a Wi-Fi module.

6. A head-up display device for a smart phone, which includes:
a satellite positioning module, which is used to receive the messages from the satellite positioning system to detect the car position;
a short-distance wireless transmission module, which is used to connect to a smart phone, send satellite positioning information to the smart phone, and receive the related display information sent from the smart phone;
a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;
a stereo audio output port, which is electrically connected to the circuit board, is used to play the music files from the smart phone, the smart phone wirelessly sends a sound signal to the short-distance wireless transmission module, the sound signal is sent to the stereo audio output port through the circuit board, the stereo audio output port is connected to a car audio, and the sound signal is played by the car audio;
a speaker, which is electrically connected to the circuit board, is used to play voice files or warning sound sent from the smart phone;
a display module, which is electrically connected to the circuit board, is installed on the display opening and used to receive the images output from the circuit board and display the image as a mirror image;
a light sensing module, which is electrically connected to the circuit board, is used to sense the brightness of the environment to modulate the brightness of the display module;
a semitransparent reflective film, which is pasted on the inner side of the front windshield of the car to display the image of the display module as mirror images.

7. The head-up display device for a smart phone as claimed in claim 6, wherein the base is placed on the instrument desk of the car, or embedded into the instrument desk under the front windshield.

8. The head-up display device for a smart phone as claimed in claim 6, further includes a microphone, which is electrically connected to the circuit board, is used with the speaker as a hands-free function.

9. The head-up display device for a smart phone as claimed in claim 6, further includes a camera lens, wherein the head-up display device is automatically switched to display the image of the camera lens as the reverse view function when the camera lens starting.

10. The head-up display device for a smart phone as claimed in claim 6, wherein the transmission of the sound signal of the stereo audio output port is through a wire connected to the AUX input port of the car audio.

11. The head-up display device for a smart phone as claimed in claim 6, wherein the stereo audio output port is a FM wireless transmitter, which is used to transmit the sound signal for the FM receiver of the car audio receiving.

12. The head-up display device for a smart phone as claimed in claim 6, wherein the short-distance wireless transmission module is a Bluetooth or a Wi-Fi module.

13. A head-up display device for a smart phone, which includes:
a portable storage media slot;
a satellite positioning module, which is used to receive the messages from the satellite positioning system to detect the car position;
a short-distance wireless transmission module, which is used to connect to a smart phone, send satellite positioning information to the smart phone, and receive the related display information sent from the smart phone;
a base, wherein a capacity space is set inside for placing a circuit board, the circuit board includes a processor, which is electrically connected to the satellite positioning module and the short-distance wireless transmission module and is used to control information processing and displaying, and a display opening is set on the surface of the base;
a stereo audio output port, which is electrically connected to the circuit board, is used to play the music files from the smart phone, the smart phone wirelessly sends a sound signal to the short-distance wireless transmission module, the sound signal is sent to the stereo audio output port through the circuit board, the stereo audio output port is connected to a car audio, and the sound signal is played by the car audio;
a speaker, which is electrically connected to the circuit board, is used to play voice files or warning sound sent from the smart phone;
a display module, which is electrically connected to the circuit board, is installed on the display opening and used to receive the images output from the circuit board and display the image as a mirror image;
a light sensing module, which is electrically connected to the circuit board, is used to sense the brightness of the environment to modulate the brightness of the display module;
a semitransparent reflective film, which is pasted on the inner side of the front windshield of the car to display the image of the display module as mirror images.

14. The head-up display device for a smart phone as claimed in claim 13, wherein the base is placed on the instrument desk of the car, or embedded into the instrument desk under the front windshield.

15. The head-up display device for a smart phone as claimed in claim 13, further includes a camera lens, wherein the head-up display device is automatically switched to display the image of the camera lens as the reverse view function when the camera lens starting.

16. The head-up display device for a smart phone as claimed in claim 13, wherein the base is placed on the instrument desk of the car, or embedded into the instrument desk under the front windshield.

17. The head-up display device for a smart phone as claimed in claim 13, wherein the stereo audio output port is a FM wireless transmitter, which is used to transmit the sound signal for the FM receiver of the car audio receiving.

18. The head-up display device for a smart phone as claimed in claim 13, wherein the short-distance wireless transmission module is a Bluetooth or a Wi-Fi module.

19. The head-up display device for a smart phone as claimed in claim 13, further includes a microphone, which is electrically connected to the circuit board, is used with the speaker as a hands-free function.
